(19) United States
(12) Patent Application Publication
(10) Pub. No.: US 2025/0381736 A1
(43) Pub. Date: Dec. 18, 2025

(54) ADDITIVE MANUFACTURING APPARATUS AND METHOD OF OPERATION

(71) Applicant: Stratasys Powder Production Ltd., London (GB)

(72) Inventors: Anders HARTMANN, London (GB); Emanuele D'ANGELO, London (GB); Marcel GARRIDO BARRABES, London (GB)

(21) Appl. No.: 18/877,767

(22) PCT Filed: Mar. 22, 2024
(86) PCT No.: PCT/GB2024/050786

§ 371 Date: Dec. 20, 2024

(30) Foreign Application Priority Data
Mar. 29, 2023 (GB) 2304672.5

(51) Int. Cl. B29C 64/364; B29C 64/393; B33Y 30/00; B33Y 40/00; B33Y 50/02

(52) U.S. Cl. CPC B29C 64/364; B29C 64/393; B33Y 30/00; B33Y 40/00; B33Y 50/02

(57) ABSTRACT

An additive manufacturing apparatus for 3D object formation includes a process chamber, a gas extraction duct and a controller. The gas extraction duct main and secondary ducts. The main duct has an extraction opening connectable to an extraction source and an inflow opening drawing in gas from an external environment. The secondary duct has an inlet opening connected to a process chamber outlet and an outlet opening coupled to the main duct. One or more temperature sensors is thermally coupled to the gas flow temperature within the interior of the gas extraction duct. The temperature sensors include an extraction temperature sensor and/or an inflow temperature sensor. A heater is arranged to provide a baseline temperature to the inflow temperature sensor. The controller determines, based on the temperature measurements, whether a gas flow rate applied by the extraction source is within a predefined range.

### FIELD OF THE INVENTION

The present disclosure relates to an apparatus for the formation of 3D objects by additive manufacturing. More particularly, the present disclosure relates to the determination of extraction flow of hot process gas from an internal process chamber by an external extraction source. For example, the process chamber may be comprised in a powder bed fusion apparatus for the formation of 3D objects by selective fusion or melting. A method of determining extraction flow rate is also disclosed.

### BACKGROUND

Powder bed fusion processes such as laser sintering and print and sinter processes have received significant attention in recent years as their throughputs become attractive for industrial manufacture. Such processes generate 3D objects in a hot dusty process chamber that requires extraction to maintain a stable and safe operating environment. The extracted gas is replaced typically with significantly cooler gas flowing into the process chamber. The gas flow through the chamber has a direct impact on the thermal environment within the process chamber and thus on the stability of the build process.

In industrial manufacturing set ups, extraction is typically provided at factory level and shared between multiple equipment. Often the extraction flow to individual apparatus is not known, or special interfacing with external components is required to monitor extraction flow rate for quality control of the build process. Such interfacing may change between different sites. Since the extraction flow affects the thermal conditions of the build process, it is at least desirable, if not a requirement for certified manufacture, that extraction flow rate can be continuously and reliably monitored for quality assurance. Part throughput may also be improved by enabling taking early measures when extraction fails or is not within the required range. Without knowledge of the stability of the process chamber environment, a build process may be failed only after completion, or fail late into the build process, thus wasting time and resources.

Improvements are therefore needed that allow monitoring of extraction flow rate throughout operation of the apparatus to allow taking early corrective action and improve throughput and quality assurance of 3D object formation.

### SUMMARY

The invention is set out in the appended independent claim, while particular embodiments of the invention are set out in the appended dependent claims.

### BRIEF DESCRIPTION OF THE DRAWINGS

Reference is now directed to the drawings, in which:

FIG. 1 is a flow chart illustrating steps of a method of determining an extraction flow rate according to the invention;

FIG. 2 is a schematic cross section side view of an apparatus configured to implement the method of FIG. 1;

FIG. 3 is a schematic cross section side view of an alternative of FIG. 2;

FIG. 4 is a variant of the extraction duct of FIGS. 2 and 3;

FIG. 5 is a graph illustrating measured temperature during the warm up phase;

FIG. 6 is a variant of FIG. 5 where the main duct sensor is at baseline temperature;

FIG. 7 is a schematic cross section side view of an additive manufacturing apparatus comprising a variant of the extraction ducts of FIGS. 2 to 4;

FIG. 8 illustrates a variant of the extraction duct of FIG. 7;

FIG. 9 is a variant of the duct of FIG. 2 or 3,

FIG. 10 is a variant of the duct of FIG. 9;

FIG. 11 is a graph illustrating test data temperature measured at various locations of the duct of the apparatus of FIG. 7 over different flow regimes;

FIG. 12 is a graph illustrating the behaviour of a ratio between temperature measured by an extraction thermistor and an inflow thermistor during the warm up phase of FIG. 11;

FIG. 13 is a schematic cross section side view of an additive manufacturing apparatus comprising an extraction duct; and

FIG. 14 is a schematic illustration of temperature in the chamber over three operational phases.

In the drawings, like elements are indicated by like reference numerals throughout.

### DETAILED DESCRIPTION

Processes carried out within a process chamber at elevated temperature and requiring stable extraction are for example additive manufacturing processes. They may be powder bed fusion processes, by which 3D objects are formed by consolidating, through heating and melting, cross sections of each object layer by layer. In such processes, significant temperature differentials are to be avoided to prevent curling of the molten layer as it cools. The top surface of the powder is therefore heated to a temperature close to the melting temperature by one or more heat sources, such as a scanning heat source in combination with a fixed overhead heater array. Selective melting may be achieved by for example tracing the cross section with a laser, or by printing infrared absorber over the cross section and heating the layer with an infrared heat source. The process space may be supplied by unheated gas that is suctioned into the process chamber by applying extraction to a process chamber outlet. Absence of extraction flow, or extraction flow above or below a predefined flow rate, may lead to poor control over the thermal stability of the object build process, affecting object quality, and may even lead to a failed build process. It is therefore desirable to measure and/or monitor the extraction flow rate during the operational process of the apparatus, which usually comprises warm up phase to reach thermal equilibrium before the build phase is initiated, and a cool down phase after the build phase. It may be difficult to determine the flow rate from, and interface with, an external source of extraction, especially where the extraction source serves a factory floor and is shared between several, and potentially different, apparatuses. Preferably, from an apparatus control point of view, the measurement capability is provided within the apparatus to avoid relying on and having to cater for interfacing with external extraction equipment. Furthermore, each apparatus may have individual extraction requirements that require monitoring at apparatus level. While flow meters may be installed inside the extraction duct of the apparatus, for example near a location at which the external extract is coupled to the apparatus, they are prone to erroneous readings since they accumulate debris from the hot environment and are difficult to service due to their location. Furthermore, many devices capable of measuring flow are not suitable for environments hotter than 60° C., which may typically be exceeded within ducting of a powder bed fusion apparatus, for example.

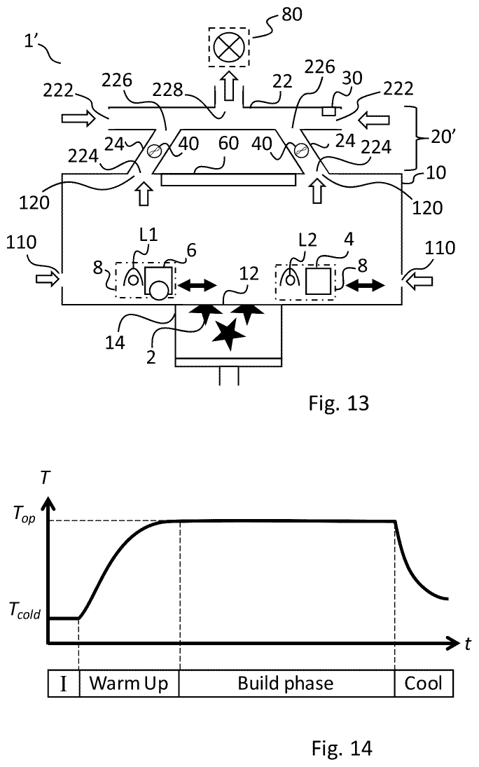

To illustrate an example of an apparatus comprising an internal extraction duct, reference is first made to FIG. 13, which is a schematic cross section side view through a process chamber 10 and extraction duct 20′ of a print and sinter apparatus 1′. The chamber comprises two carriages 8 moveable over a build area 12 as indicated by the solid arrows. The build area comprises a build volume 14 within which objects 2 are formed. The left hand carriage comprises a distribution module 6, such as a roller, and a preheat heat source L1 for preheating each newly distributed layer. The right hand carriage comprises a printhead module 4 and a fusing heat source L2 for sintering or fusing after printing. Facing the build area 12 from above is a further heat source 60, also for heating the layer surface. Typically, such a heat source comprises an array of individually addressable heaters to maintain the layer surface at a uniform temperature. These heat sources thus contribute to the temperature of the process chamber environment, which for a polyamide like PA11 may be around 80-120° C. The atmosphere in the process chamber 10 comprises powder particles and print fluid vapour, and to maintain a stable environment these need to be extracted. Furthermore, the temperature within the environment is to be stable. For this reason, the hot gas, which may simply be air, is extracted from the process chamber using an external extraction source 80 (shown in dashed outline and not part of the apparatus) via an extract duct 20′ of the apparatus. In the Figures herein, open arrows indicate gas flow direction during normal operation unless otherwise described. The process chamber 10 comprises inlets 110, here shown at either side wall of the chamber 10 at the extreme ends of the movement of the carriages, and through which air can enter from the environment outside of the chamber 10 by the negative pressure generated in the chamber to extract gas. In the ceiling of the chamber, to either side of the heater 60, chamber outlets 120 are provided. They may be elongate outlets aligned with each side of the build area 12. The extract duct 20′ comprises a main duct 22 and two secondary ducts 24. The inlet opening 224 of each secondary duct is coupled to a respective chamber outlet 120. The outlet opening 226 of each secondary duct is coupled to the main duct 22 at location between the two openings 222 of the main duct, and to either side of an outlet of the main duct that is an external extract interface 228 to the external extract. With the external extract 80 connected and working, gas is suctioned through the chamber from the chamber inlets 110 to the external extract interface 228 via the chamber outlets 120, secondary ducts 24 and a portion of the main duct. The secondary ducts may each comprise a flow device 40, as shown, which may be a fan that controls a flow rate of hot gas out of the chamber. The external extraction source 80 may apply a significantly higher flow rate than the fans which, in the absence of the first and second openings, would overpower the fans. Therefore, the first and second opening of the main duct allow gas such as air from the external environment to enter the main duct in response to the extraction flow suction and relieve the suction applied to the fans. In this way, the fan speed and therefore the extraction rate through the secondary ducts remains controllable.

A typical operational cycle of the apparatus may comprise a warm up phase, a build phase and a cool down phase. This is illustrated in FIG. 14 by a thermal cycle indicating a thermal state of the process. In FIG. 14, a graph schematically plotting surface temperature of the build area as monitored from a cold start of the apparatus may be used to indicate chamber temperature and is merely an example. Other temperature measurements suitable to represent the temperature of the chamber environment may be used. At the start of the operational cycle, the apparatus is at a temperature T_{cold} below an operational target temperature, Tₒₚ. The build bed surface is also at T_{cold}. T_{cold} may be ambient temperature. During the warm up phase, the temperature of the build bed surface is brought to a steady state temperature represented by the operational target temperature Tₒₚ. The operational target temperature Tₒₚ indicates when thermal equilibrium is achieved and may be represented by the temperature of other components within the process chamber, or may be a direct measurement of the gas temperature within the process chamber. Operating at the operational target temperature may mean that every distributed layer is heated with similar power input from the various heat sources, and the average temperature measured of the surface of each layer remains stable at the target build surface temperature. During the warm up phase, the chamber environment heats up, leading to increasingly hotter gas being extracted until equilibrium is reached. Preferably, at Tₒₚ, the temperature of the process chamber environment is stable also. At this condition, the build phase may be initiated to build 3D objects. After the build phase, a cool down phase causes the build bed surface temperature and the temperature of the process chamber gas to fall before the 3D objects are removed.

The external extraction source 80 is typically an independently controlled system that cannot be controlled by, or interface with, the apparatus. By providing one or more active flow control devices 40, such as fans or baffles, the flow rate of gas drawn out of the process chamber 10 into the extraction duct 20 may be adjustable and controlled. Several issues may arise when the external extraction source does not extract at the expected flow rate.

If the external extraction source 80 has not been connected properly, or fails, or if the flow of extraction is too low to sufficiently remove hot process chamber gas, the build chamber temperature will rise to a higher level than expected or desired. The overhead heater 60 is typically controlled based on feedback from temperature measurements of the build bed surface 12. As the process chamber temperature rises, the build area temperature rises, and the overhead heater 60 begins to operate at reduced activity to avoid overheating the build area. This leads to poor control over the uniformity of the temperature distribution of the build area. Without reliable means to measure the extraction flow rate, this issue may only become apparent at a later time during, or even only after, the operational process, leading to lost time and wasted powder, since typically the unfused powder will have significantly degraded at excessive temperatures, and parts outside of required part quality need to be discarded.

Insufficient extraction may be flagged during the build process by providing a temperature sensor 30, such as a thermistor, at or near the first and second openings 222 and monitoring the temperature measured by the thermistor. With no or insufficient extraction, hot gas is drawn out of the chamber by the fans 40 and pushed out of the main duct 22 as backflow through the first and second openings 222. This may be a safety issue, and the apparatus may be configured such that once the temperature sensor measures a temperature above a predefined threshold, the build process may be stopped. The temperature sensor 30 in FIG. 13 can only be used to flag absence of, or insufficient, flow of extraction once the temperature in the process chamber has risen above a certain value compared to ambient. At this point, valuable time is lost, lowering the throughput of the apparatus and increasing running costs. It is therefore desirable to detect such issues before, or early on during, the warm up phase.

The extraction flow applied may also be too high and overpower the fans despite gas entering the main duct from the first and second openings. The feedback controlled overhead heater may compensate for any decrease in the build bed temperature due to the increased flow, which may stress the individual heaters and lead to failure. It can also lead to degradation of the powder, both of which are undesirable.

Furthermore, it is desirable to monitor whether the extraction flow rate is stable throughout the build process. This may support certification of parts. A variable flow during the build phase may only be implied subsequently by other monitored values, such as by an erratic power input behaviour of the heaters of the overhead array 60. It is desirable to give the user the opportunity to rectify insufficient or excessive flow rates, particularly during the warm up phase. Temperature measurements from a temperature sensor 30 as described for FIG. 13 are not suitable to detect excessive flow, or variable flow that does not lead to a build up of temperature in the main duct.

Improvements are therefore needed that allow monitoring the flow rate provided by an external extraction source at various stages of the operational cycle, and within apparatus from which a “hot” chamber requires stable extraction at predefined flow rate ranges. Furthermore, it is desirable that such measurements are provided by onboard components of the apparatus, independent from the external extraction source.

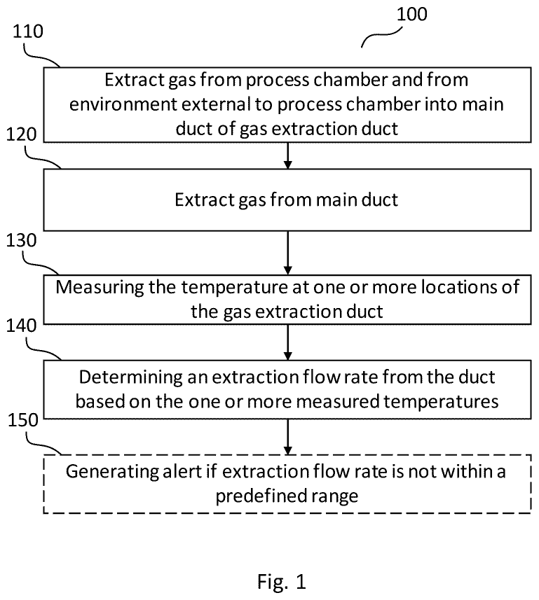

The inventors have recognised that solutions allowing reliable determination of extraction flow rate throughout the operational process phases of the apparatus may be obtained by evaluating temperature measurements by one or more temperature sensors arranged at suitable locations of an extract duct of the apparatus. Embodiments according to the invention and their variants will now be described with reference to FIGS. 1 to 14.

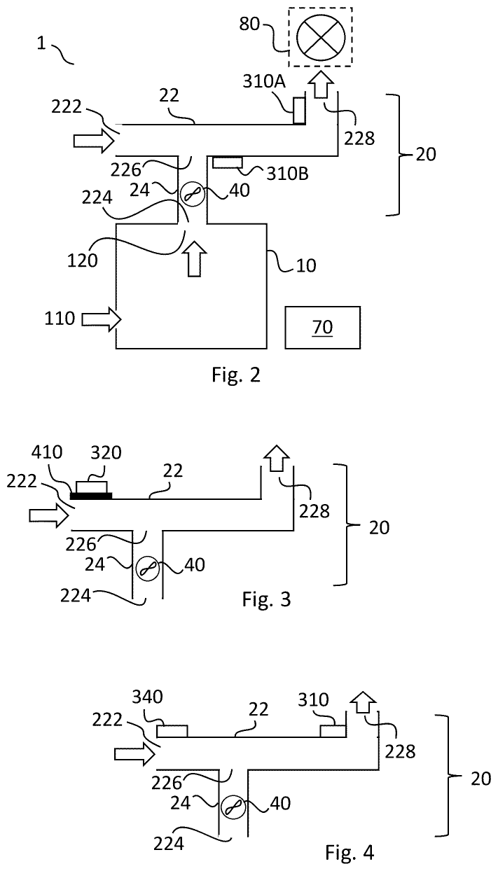

FIG. 1 is a flow chart illustrating a method 100 of determining a flow rate applied by an external extraction source based on temperature measurements at one or more locations of an extraction duct of an apparatus that will be described with reference to FIGS. 2 to 12. The extraction duct 20 is coupled to a process chamber 10 from which gas is to be extracted. The extraction duct comprises a main duct 22, the main duct 22 having an extraction opening 228 connectable to the external extraction source 80 and an inflow opening 222 configured to draw in gas from an environment exterior to the process chamber; and a secondary duct 24 having an inlet opening 224 connected to the process chamber outlet 120 and an outlet opening 226 coupled to the main duct 22 between the extraction opening 228 and the inflow opening 222. The method comprises the steps of:
At block 110, extracting gas from the process chamber 10 into the extraction duct 20, for example by operating one or more flow devices 40 such as fans comprised within the extraction duct, for extraction from the apparatus by the external extraction source;
At block 120, extracting gas from the main duct 22 of the extraction duct 20 by the external source of extraction 80 while suctioning in gas from the inflow opening 222 of the main duct 22 from the environment external to the process chamber 10;
At block 130, measuring temperature at one or more locations of the extraction duct 20; by one or more of:
an extraction temperature sensor 310 arranged at a location at, or between, the extraction opening 228 of the main duct 22 and the outlet opening 226 of the secondary duct 24; and
a main duct temperature sensor 320 arranged between the inflow opening and the extraction opening 228 of the main duct 22, and a heater 410 configured to provide a baseline temperature, elevated from that of the external environment, to the main duct temperature sensor 320. Optionally, one or both may be provided in addition:
an inflow sensor 340 arranged at or adjacent the inflow opening 222 of the main duct 22 and configured to measure the temperature of ambient gas at the inflow opening 222; and
a process chamber temperature sensor 330, located within the process chamber 10, or at one of or between the process chamber outlet 120 and the secondary duct outlet 226, and configured to detect a temperature of the gas within the build chamber 10. Each temperature sensor is configured to detect, either directly or indirectly, the temperature of the gas within the duct (or within the process chamber, in the case of the process chamber sensor 330) at its specific location;
At block 140, determining whether an extraction flow rate is present, or within a predefined range, based on the measured temperature at the one or more locations, by comparing the one or more measured temperatures to a predefined temperature or a predefined range of temperatures. The measured temperature(s) may for example be used to determine, from a predetermined behaviour of extraction flow rate versus measured temperature, whether the measured temperature falls within an allowable predefined range that indicates a sufficient extraction flow; and
At block 150, generating an alert if the determined extraction flow is not present or outside the allowable range. The allowable range may be different for different phases of the operational cycle. The location of and use of measurements from the various temperature sensors will now be described with reference to FIGS. 2 to 12. “Directly sensing temperature” of the gas is intended to mean herein that the temperature sensor may be exposed to the gas itself by being mounted to an inner wall, or reaching through the wall, of the duct. “Indirectly sensing temperature” of the gas is intended to mean herein that the temperature sensor may be mounted outside of the duct but is thermally coupled to the interior, for example the duct wall may be thermally conductive and the temperature sensor may be mounted to the outside of the thermally conductive wall. The indirectly measured gas temperature may indicate the actual gas temperature rather than being the exact value of the gas temperature. The temperature sensors may be provided inside or outside the duct wall. Where a temperature sensor is arranged to an outside portion of the duct wall, in thermal communication with the interior of the duct (for example by the duct wall being sufficiently thin to efficiently transmit heat and/or a thermally conductive material). Such a temperature sensor may be thermally insulated from the environment surrounding the duct. Alternatively, the readings taken by the temperature sensor may be normalised against the thermal environment outside of the duct. Preferably, any one, or any combination, of the temperature sensors described herein is mounted to an exterior surface of the duct 20 while being thermally coupled to the interior atmosphere of the duct. For example, the duct wall may be thermally conductive. In this way, the thermistor is protected from the hot dusty environment inside the duct, and easily accessible for maintenance. Alternatively, the extract thermistor 310 and/or inflow thermistor 340 described herein may be mounted to an interior surface of the duct 20; however, a thermistor located inside the duct may collect debris from the hot gas atmosphere and measurements may become unreliable over time; meanwhile its position inside the duct may make maintenance cumbersome.

Herein, the various temperature sensors will be illustrated in form of thermistors, however any other suitable temperature sensors may be used, such as thermocouples, thermopiles, or infrared sensors, and/or other type of suitable temperature sensors. The apparatus may comprise the same type of temperature sensor or a mixture of types of temperature sensor.

FIG. 2 and FIG. 3 are schematic cross section side views of an apparatus 1 configured to carry out the method of FIG. 1 and illustrating embodiments of the invention, preferably for use during different stages of or before the start of the operational cycle. In both Figures, the apparatus 1 comprises a process chamber 10 from which gas is to be extracted by an external source of extraction 80, wherein, during use, the chamber 10 comprises gas at a temperature higher than gas in an environment external to the process chamber. The apparatus may be an apparatus for manufacture of 3D objects formed within the chamber, or a post processing apparatus in which the surface of parts is melted or partially melted to adjust surface properties. The chamber 10 has a chamber inlet 110 allowing gas to enter the chamber from an exterior environment. The gas entering the chamber 10 may be at ambient temperature.

The apparatus comprises a gas extraction duct 20 configured to guide gas out of the chamber 10, and a controller 70; wherein the gas extraction duct 20 comprises:
a main duct 22 having an extract opening 228 connectable to an external extraction source 80 and an inflow opening 222 configured to allow in gas from an environment exterior to the chamber 10 as a result of applying extraction by the external extraction source 80;
a secondary duct 24 having an outlet opening 226 coupled to the main duct 22 between the extract opening 228 and the inflow opening 222, and an inlet opening 224 connected to a chamber outlet 120 which may be comprised within the ceiling of the chamber 10 as shown in FIG. 2; and one or more temperature sensors 310 thermally coupled to the interior of the gas extraction duct 20, and arranged to measure temperature of gas flowing through it, either directly or indirectly, at one or more locations within the gas extraction duct 20. The inflow opening 222 is provided to relieve negative pressure in the main duct 22 as described with reference to FIG. 13. The flow resistance between the inflow opening 222 and the main duct outlet 228 compared to the flow resistance between the secondary duct inlet 224 and the main duct outlet 228 is such that the flow rate through the secondary duct 24 remains controllable by the flow device 40 over a defined range of extraction rate applied by the external source of extraction 80.

FIG. 2 illustrates a first embodiment comprising one or more extraction temperature sensors 310. To illustrate different locations, a first extraction temperature sensor 310A and a second extraction temperature sensor 310B, are shown. The first extraction temperature sensor 310A is located at or near the extraction outlet 228, mounted to an external surface of the duct wall and thermally coupled to an interior of the main duct 22. The second extraction temperature sensor 310B is located at or near the secondary outlet 224, also mounted to an external surface of the duct wall and thermally coupled to an interior of the main duct 22.

FIG. 3 illustrates a second embodiment in which a main duct temperature sensor 320 and a heater 410 arranged to provide a baseline temperature to the main duct temperature sensor are mounted to the main duct. As an example, the heater may be a heat pad mounted between the main duct sensor and an exterior surface of a thermally conductive wall portion of the main duct 22. The main duct sensor 320 may be located at or near the inflow opening 222, or at or near the outlet opening 228, or at any location between along the main duct 22. The main duct temperature sensor 320 may be mounted to an internal surface of the main duct 22, and the heater 410 may be mounted between the main duct temperature sensor 320 and the internal surface of the main duct 22. Alternatively to the arrangement shown in FIG. 3, the main duct temperature sensor 320 may be mounted to an external surface of a thermally conductive wall portion of the main duct 22, between the heater 410 and the external surface of the main duct. Alternatively, the heater 410 may be mounted to an internal or external surface of the main duct 22 and adjacent and/or thermally coupled to the main duct temperature sensor 320.

Temperature measurements by these temperature sensors may be used during different stages of the operational phases to determine extraction flow applied by the external extraction source 80 (here only shown in FIG. 2) as will be described below. The controller 70 is configured to determine, based on the measured temperature at the one or more locations during use of the apparatus, whether an extraction flow rate applied by the extraction source 80 is within a predefined, allowable range.

### Extraction Flow Determination During Build Phase

FIG. 2 illustrates an extract thermistor 310 thermally coupled to the interior environment of the main duct 22. It is located to measure the temperature of the combined gas flow from the secondary duct 24 and the inflow opening 222 during the steady state or build phase of the apparatus, and to determine whether an extraction flow is within a predefined range when the process chamber 10 is at a temperature that is significantly above ambient, wherein ambient temperature may be represented by the temperature of the gas entering, or external to, the inflow opening 222. The controller 70 may be configured to determine, or to receive an indication, that the chamber environment is at a suitably elevated temperature from ambient. Upon determining (or upon receiving an indication) that the chamber environment is at a suitably elevated temperature above ambient temperature, the controller is arranged to compare the temperature measured by the extraction thermistor 310 to a range of predetermined temperatures indicating an allowable range of flow rates. Alternatively, the controller 70 may be configured to compare the measured temperature against a predetermined behaviour of measured temperature versus flow rate, and determine a corresponding flow rate. The controller may therefore be used to predict the extraction flow rate based on feedback by the extract thermistor 310, and to compare whether the predicted flow rate falls within an allowable, predefined range of flow rates.

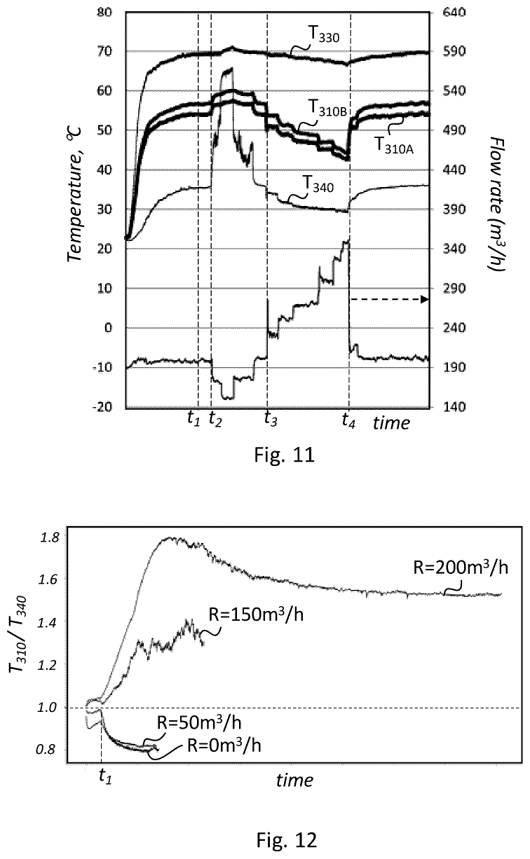

Thus, the measured temperature may be compared to a predetermined model of extract flow rate against temperature measured by the extract thermistor 310, and the determined flow rate may be compared to a predetermined allowable range of flow rate. If the determined flow rate is too low, or is inexistent, the controller may generate an alert to the user to adjust the flow rate or initiate the extraction flow (and/or to increase the flow rate to a value within the predetermined allowable flow rate range); if the determined flow rate is too high, the controller may generate an alert to the user to adjust the flow rate (to reduce the flow rate to a value within the predetermined allowable flow rate range). It is desirable that the controller is configured to generate an alert in a timely manner, so that the flow rate can be adjusted without delay before impacting the overall operation of the apparatus. It is therefore beneficial to pre-model the flow rate trend (or a temperature trend indicating flow rate trend) on the predetermined training dataset of temperature and flow rate, and adapt the controller 70 to determine in real time whether, based on the temperature measured by the extract thermistor 310, the flow rate is within an expected range. The correlation in flow rate to the temperature measured by the extract temperature sensor 310 will be illustrated below with reference to test data in FIG. 11.

Any of the variants described herein may be used in combination with an inflow thermistor 340 located at or adjacent the inflow opening 222 of the main duct 22 (as for example shown in FIG. 4). Should the extraction source 80 fail, or should the level of extraction fall below a safe level, hot gas is drawn from the chamber by the flow device 40 (in form of a fan) and pushed into the main duct 22 and out of the inflow opening 222. As a result the temperature measured by the inflow thermistor 340 rises. The controller 70 may be configured to monitor the measured temperature by the inflow thermistor 340, compare it to a predefined threshold temperature indicating an unsafe level of extraction, and, based upon determining that the measured temperature exceeds the predefined threshold, to generate an alert indicating that the extraction flow is too low. Optionally, generating the alert may comprise stopping the operating of the apparatus, such as aborting the present operational phase of the apparatus and switching off any or all of the heat sources and 3D model forming components. When the process chamber is heating up or hot, the predefined threshold temperature may therefore represent a backflow of hot gas from the chamber via the secondary duct and main duct out of the inflow opening due to insufficient extraction flow. The apparatus may be safely shut down before excessive heat and fumes develop in the chamber due to lack of sufficient extraction.

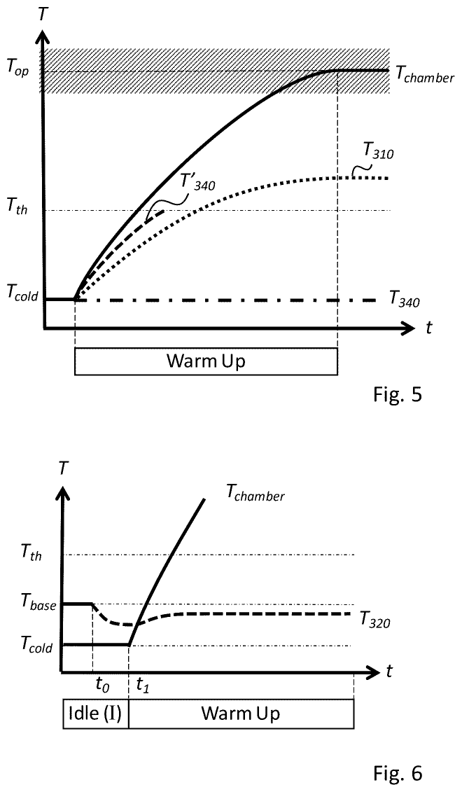

FIG. 5 is a graph schematically illustrating temperature curves over time during the warm up phase of the chamber 10. The chamber temperature is represented by T_{chamber}, starting from T_{cold} which may be ambient temperature. The steady state temperature may be determined by any suitable means and is herein illustrated as the chamber environment temperature T_{chamber}, and which may be the hottest gas temperature in the apparatus. The measurements by the extract thermistor 310 and the inflow thermistor 340 are also illustrated, labelled T₃₁₀ and T₃₄₀ respectively. After the warm up phase is initiated, the thermal state moves towards the equilibrium operational thermal state. For example, where the apparatus is a print and sinter apparatus, the heat sources L1, L2 and further heat source 60 may be operated. As a result, the temperature of the process chamber 10 and the gas within the process chamber increases. For normal operational extraction flow by the external extraction source 80, the temperature of the gas measured at or near the extract opening 228 is always expected to be below the chamber temperature T_{chamber}, since the extraction source draws relatively colder (ambient temperature) gas from the inflow opening 222 to mix inside the main duct 22 with the hot process gas from the secondary duct 24. During start up of the apparatus, as the process chamber temperature rises, and with the extraction source 80 working, the temperature at the extraction outlet 228 slowly rises corresponding to the chamber temperature increase. The temperature due to the combination of the two gas flows is indicated by the dotted curve T₃₁₀ as may be measured by the extract thermistor 310. Meanwhile, with the extraction flow present and sufficient, the temperature measured at the inflow thermistor 340 may remain at substantially ambient temperature T_{cold}, as illustrated by the horizontal dotted-dashed line, T₃₄₀.

If extraction flow is however not present at the start of the warm up phase, an active flow device 40 located in the secondary duct 24, such as a fan, will push heated gas from the process chamber 10 into the main duct 22 and out of the inflow opening 222. The temperature as measured by the inflow thermistor 340 will rise as a result, and in correlation with the rising chamber temperature. This is shown by the dashed curve T′₃₄₀. As the temperature in the process chamber 10 rises, and the extraction source 80 remains inactive, the measured temperature will reach the predefined safe threshold temperature Tₜₕ. The controller 70 may be configured to generate an alert upon detecting that the predefined safe threshold temperature Tₜₕ has been reached, which may comprise controlling the apparatus 1 to shut down operation. In this way, the inflow thermistor 340 may be used to detect the absence of extraction at some point during the warm up process. However, this arrangement may not reliably distinguish between total absence of extraction and low extraction.

### Extraction Flow Determination During Warm Up Phase

FIG. 3 illustrates a main duct temperature sensor 320 mounted on or adjacent to a heater 410, such as on a heat pad. The heater 410, or heat pad, is operable to provide to the main duct temperature sensor 320 a baseline temperature that is above ambient temperature (as for example measured by the inflow thermistor 340 as described herein) and below a predefined threshold temperature. The predefined threshold temperature may represent a limit for safe operation Tₜₕ, such as representing backflow of gas from the process chamber 10 via the secondary duct 24 and main duct 22 out of the inflow opening 222 due to insufficient extraction flow. The heat pad is configured to provide the main duct temperature sensor 320 with a minimum temperature, or baseline temperature, T_{base}. The baseline temperature is chosen to lie between ambient temperature and the threshold temperature that allows temperature measurements distinct from ambient temperature. During an idle time of the apparatus at which the process chamber 10 is at substantially ambient temperature, and in absence of extraction, the main duct temperature sensor 320 measures the baseline temperature. This temperature difference provided by the heater 410 allows detection of extraction flow in idle mode of the apparatus, and before the start of an operational cycle. In idle mode, and with the temperature sensor 320 heated by the heater 410 to baseline temperature, the extraction flow may be initiated. Gas is extracted from the main duct 22 and gas at ambient temperature is drawn into the inflow opening 222 by the external extraction source 80. Compared to the baseline temperature, the relatively colder ambient gas flowing from the inflow opening 222 past the main duct temperature sensor 320 and cools it, causing the main duct temperature sensor 320 to measure a temperature below the baseline temperature.

The temperature behaviour as may be measured by a main duct temperature sensor 320 of FIG. 3 during an idle phase I is illustrated in FIG. 6. FIG. 6 is a schematic plot of temperature T₃₂₀ measured by the main duct temperature sensor 320. The chamber temperature is again represented by T_{chamber}, starting from T_{cold} which may be ambient temperature. Initially the extraction flow is OFF to allow the heat pad to reach the baseline temperature, T_{base}. At ambient temperature, and before the extraction source 80 is connected or switched on, the main duct temperature sensor 320 measures the baseline temperature T_{base}. At t₀, the extraction source 80 is engaged within an allowable range of extraction flow, applied by the external source of extraction 80. Gas at ambient temperature now flows into the inflow opening 222 and cools the main duct temperature sensor 320 to a temperature below the baseline temperature T_{base}. During the idle phase I between a time t₀ and t₁, the controller 70 may compare the measured temperature to the baseline temperature T_{base} and determine that the measured temperature is lower than T_{base}, and therefore determines that extraction flow is present. At t₁, the warm up phase is initiated. The chamber temperature T_{chamber} begins to rise and, due to the operation of, for example, a fan 40, or by opening of a valve in the secondary duct 24, heated gas is drawn from the process chamber 10 into the main duct 22, proportionally reducing the gas flow into the inflow opening 222. This causes the temperature T₃₂₀ measured by the main duct temperature sensor 320 to slightly increase again, but to remain below the baseline temperature, as illustrated by the dashed curve T₃₂₀.

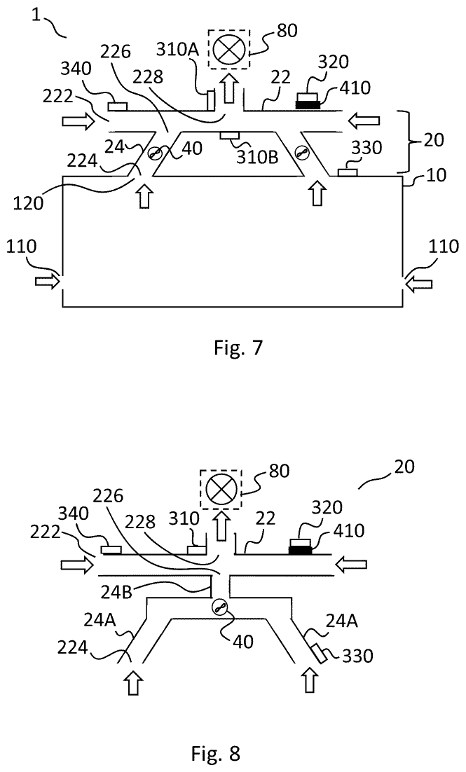

During the idle phase, or early warm up phase, the controller 70 may be configured to compare the temperature T₃₂₀ measured by the main duct temperature sensor 320 to the baseline temperature T_{base}, and either:
upon determining that the measured temperature T₃₂₀ is equal to or higher than the baseline temperature, to generate an alert that the extraction flow rate is not present or insufficient compared to an expected flow rate; or
upon determining that the measured temperature T₃₂₀ is lower than the baseline temperature, to compare the measured temperature T₃₂₀ to a predetermined model of extraction flow rate versus measured temperature, and, upon determining that the measured temperature T₃₂₀ indicates an extraction flow rate below a target range of extraction flow rates, to generate an alert that the extraction flow rate is not sufficient. The process chamber temperature T_{chamber} may be determined from measurements by a temperature sensor arranged to detect the temperature of the process chamber atmosphere, such as chamber temperature sensor 330 in FIG. 7, or indirectly by a temperature sensor 330 located in the secondary duct 24 in FIG. 8.

FIG. 5 further illustrates that the steady state temperature may be represented by a range of temperatures that indicate a range of allowable flow rates by the hatched band extending above and below the operational temperature Tₒₚ.

By providing the main duct thermistor 320 with a baseline temperature, absence of extraction flow may even be detected during an idle phase of the apparatus 1, before initiation of an operational cycle. Upon determining that the extraction flow is present during an idle time, a warm up phase may be initiated. The main duct thermistor 320 may not be sufficiently sensitive to allow an adequately accurate determination of extraction flow rate once the process chamber temperature T_{chamber} rises significantly above ambient and the gas flow entering the inflow opening 222 reduces due to hot process gas entering the main duct 22. At a predefined transition temperature in the warm up phase, the inventors have found that the measurements from the extract thermistor 310 may be used to determine a rate of extraction flow more reliably than from the main duct temperature sensor readings. This predefined transition temperature may be determined experimentally and subsequently monitored by the process chamber temperature sensor 330. The controller 70 may be configured to determine an extraction flow rate based on temperature measurements according to the two different arrangements described for FIGS. 2 and 3 and switch between them as the transition temperature is passed, as determined from temperature measurements by the process chamber temperature sensor 330. The controller may be configured to: determine, during an idle phase of the apparatus, that extraction flow is present based upon determining that the temperature measured by the main duct temperature sensor is below the baseline temperature, wherein during the idle phase the process chamber 10 is at ambient temperature; monitor, during a subsequent warm up phase during which the process chamber is heated to the operational target temperature, temperature measurements by the chamber temperature sensor 330, and upon determining that the chamber temperature is at or above a predefined transition temperature, the controller may further be configured to: monitor temperature measurements by the extraction temperature sensor 310, compare the measured extraction temperatures to a predetermined range of allowable extraction temperatures indicating an allowable range of extraction flow rates, and, upon determining that the measured extraction flow rate is outside the predetermined range, generate an alert that extraction flow is to be adjusted.

Any of the apparatus described herein may comprise the inflow temperature sensor 340 arranged to measure a temperature of gas outside the inflow opening, and/or the process chamber temperature sensor 330 arranged to measure or indicate the temperature of gas inside the process chamber 10. The inflow thermistor 340 may be provided and used to monitor the temperature outside the inflow opening 222 as ‘ambient’ temperature feedback to cross check for fluctuations in ambient temperature. Where the inflow opening 222 is within a cladding of the apparatus, the ambient temperature of gas relating to the inflow inlet 222 may be different to an ambient temperature external to the apparatus, or may change during the operation of the apparatus. The controller 70 may be configured to monitor the measured outside (ambient) temperature, and to determine, based on the measured extraction temperature and the measured outside temperature, and, where present, based upon the measured process chamber temperature, the extraction flow rate applied by the external extraction source 80, since the flow of gas from the inflow opening 222 into the main duct 22 varies proportionally with the flow of gas from the process chamber 10. The inflow sensor measurements may be used to refine the determination of flow rate by generating training data to expand the training dataset.

In an alternative to the arrangement of FIG. 3, and which may be a variant of FIG. 2, FIG. 4 illustrates an extract temperature sensor 310 and an inflow temperature sensor 340 that may be used in combination to monitor the flow behaviour during the warm up phase. The extract temperature sensor 310 is arranged at or adjacent the extract opening 228, and an inflow thermistor 340 is arranged at or adjacent the inflow opening 222. The inflow thermistor 340 is arranged to measure the temperature of the gas at the inflow opening 222 as described herein. During normal operation of the extraction source, the inflow temperature may be ambient temperature. The controller is configured to determine, or to receive an indication, that the process chamber temperature T_{chamber} is below the predefined operational target temperature and thus still in the warm up phase; and, upon the determination or indication that the process chamber temperature is below the predefined operational target temperature, to monitor measurements by both temperature sensors during the warm up phase of the apparatus and use the combination of measurements to determine whether extraction flow falls within an allowable range. An example of a combination of measurements will be described with reference to test data in FIG. 12 below. The controller 70 may be configured to compare the temperature measured by the extraction temperature sensor 310 against the temperature measured by the inflow temperature sensor 340 to determine an operational state of the extraction source. Upon determining that the temperature measured by the extraction temperature sensor 310 is lower than a temperature measured by the further inflow temperature sensor 340, the controller may generate an alert indicating that the flow of extraction is insufficient; or, upon determining, by comparing the ratio of temperature measured by the extraction temperature sensor 310 and the inflow temperature sensor 340 to a predetermined range of ratios, that an extraction flow rate is too low, generating an alert indicating that the flow of extraction is insufficient and, optionally, to stop the operation of the apparatus.

### Variants of the Extraction Duct

The description with reference to FIGS. 2 to 4 may equally apply to variants of the apparatus, which may be additive manufacturing apparatus such as a powder bed fusion apparatus described with reference to FIG. 13. These variants will now be described with reference to FIGS. 7 to 10.

FIG. 7 is a schematic cross section side view of an apparatus. The duct arrangement is as shown in FIG. 13, wherein the chamber outlet of the process chamber 10 comprises a first process chamber outlet and a second process chamber outlet 120, for example facing either side of the build area 12 that may be arranged within the floor of the chamber 10. The outlet opening of the secondary duct into the main duct 22 is in fluid communication with the first and second chamber outlets 120 via a first secondary duct 24 and second secondary duct 24, respectively. The first and second chamber outlets 120 in this variant are comprised within a ceiling of the chamber 10. The one or more chamber inlets 110 configured to pass gas from an external environment into the chamber 10 may be arranged in a process chamber side wall. Furthermore, the outlet opening 226 may comprise a first outlet opening and a second outlet opening 226, wherein the first and second secondary ducts 24 comprise the first and second outlet opening 226, respectively. As shown in the variant of FIG. 7, the inflow opening into the main duct 22 comprises a first and second inflow opening 222 arranged symmetrically about the extract outlet 228, and the first and second secondary ducts 24 comprise the respective first and second outlet openings 226 that are directly coupled to the main duct 22. The first and second secondary duct 24 each comprise a flow control device 40. This allows individual control of the flow rate of gas out of the chamber 10 through each of the two secondary ducts by adjusting the flow control device 40. This may for example allow balancing against different flow resistances posed by for example different flow path lengths of the first and second secondary duct, such that the flow rate through each secondary duct is substantially the same.

Alternatively, and as shown in a variant of the gas extract duct 20 in FIG. 8, the first and second secondary ducts 24A may be combined at a combined portion 24B, such that the outlet opening 226 is the outlet of the combined portion, and wherein the combined portion comprises a single flow control device 40. This alternative may be a lower cost option since only one flow device is required, and the flow resistance of each secondary duct may be designed to achieve balanced extraction flow rates through the two secondary ducts.

FIGS. 7 and 8 further shows example locations for the extract thermistor 310A and 310B at positions at each or either of or between the one or more outlet openings 226 and the extract outlet 228, or adjacent the extract outlet; a main duct thermistor 320 on a heater 410; and an inflow thermistor 340 arranged at one of the two inflow openings 222 into the main duct 22. It is not necessary that the main duct 22 comprises two inflow openings; instead, a single inflow opening 222 may be provided as shown for example in FIGS. 2 to 4.

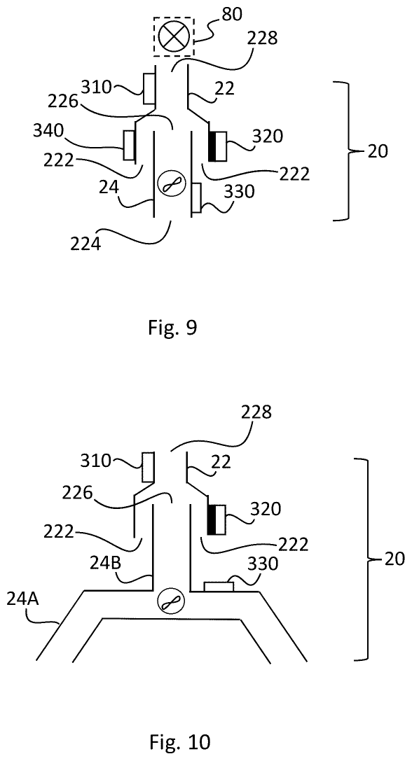

FIGS. 9 and 10 are variants of the apparatus of FIG. 2, in which the extract duct 20 has been simplified. The secondary duct arrangements may be the same as described in the variants herein. In FIG. 9, the end portion of a single secondary duct 24 comprising the secondary outlet 226 is partially inserted into a larger diameter end portion of the main duct 22, such that a gap between the inner wall of the main duct portion and the outer wall of the secondary duct portion forms an annular inflow opening 222. The opposite end of the main duct 22 is the extract opening 228 couplable to the external extraction source 80. The extract duct 20 comprises one or more of: an extract temperature sensor 310 as described herein and arranged at or near the extract opening 228 of the main duct 22; a main duct temperature sensor 320 thermally coupled to a heater 410; optionally an inflow temperature sensor 340 arranged at a wall surface of the main duct at the inflow opening and in thermal communication with the temperature interior to the main duct as described herein; and optionally a chamber temperature sensor 330 arranged on the secondary duct or in the process chamber of the apparatus as described herein. The one or more thermistors may be used as described herein.

FIG. 10 is a variant of FIG. 9 in which two secondary ducts 24A are coupled to a combined portion 24B of the secondary duct 24, and the secondary outlet 226 is the outlet of the combined portion 24B. In analogy to FIG. 9, the end portion of the combined portion 24B of the secondary duct comprising the secondary outlet 226 is partially inserted into the larger diameter end portion of the main duct 22, such that a gap between the inner wall of the main duct portion and the outer wall of the secondary duct portion forms an annular inflow opening 222. The opposite end of the main duct 22 is the extract opening 228 couplable to the external extraction source 80. The various temperature sensors may be arranged and used as described herein. In this variant, the chamber temperature sensor 330 may be arranged on or adjacent the combined portion, or in any suitable location to indicate the chamber temperature.

Any one of the flow devices 40 described herein may comprise any or any combination of a fan and a flow restrictor, such as a baffle or a valve, that may be adjusted to vary the flow rate through the secondary duct(s). Where more than one secondary duct is provided, each secondary duct may comprise a flow control device.

### Examples of Thermistor Measurements

By using a print and sinter apparatus having the extract duct according to FIG. 7, tests were carried out to generate sets of predetermined data. The extraction flow was applied by an extract source 80 that could be annually regulated, and flow rate was measured by a flow meter on the external extract side. The two secondary ducts comprised a fan each that were operated at steady flow rates throughout the tests. An inflow thermistor 340 was arranged directly on the thermally conductive main duct portion. A first extract thermistor 310A was arranged in a position adjacent the extract outlet 228 of the main duct 22, similar to extract thermistor 310A of FIG. 7. A second extract thermistor 310B was arranged on an external surface of the main duct between the two secondary duct outlets, similar to extract thermistor 310B of FIG. 7. The chamber thermistor 330 was represented by a thermistor comprised within the secondary duct 24 as part of the assembly of the fans 40.

FIG. 11 illustrates a graph of flow rate applied by an external source of extraction 80 as measured by a flow meter against time starting from a cold, ambient temperature of the process chamber. The flow rate is plotted on the secondary y-axis. The primary y-axis represents temperature as measured by the four different thermistors. Curves T_{310A} and T_{310B} plot the temperature measured by the first extract thermistor 310A and second extract thermistor 310B, respectively. A curve T₃₄₀ plots the temperature measured by the inflow thermistor 340. The minimum temperature measurable by the inflow thermistor 340 is thus the ambient temperature. A fourth temperature curve T₃₃₀ (or T_{chamber}) plots the temperature measured by the chamber thermistor 330. The flow rate applied is initially a steady 200 m³/h that represents a target operational flow rate. It can be seen from all four curves that the temperature ramps up during a warm up phase, e.g. until a time t₁, while applying the steady extraction flow rate. The steady state process chamber temperature may be indicated around 70° C. as measured by the chamber thermistor 330 and may indicate that the operational temperature Tₒₚ has been reached. The inflow thermistor 340 also measures an increase in temperature, as the immediate environment around the inflow opening also warms up. In this case it reaches around 35° C. during normal operation. The threshold temperature may be set as a temperature above 35° C. During normal operation, the extract thermistors 310A, 310B measure an expected temperature T_{310A}, T_{310B} that falls between the chamber temperature T₃₃₀ and the inflow temperature T₃₄₀. It can be seen that the thermal response by the two extract thermistors is very similar in temperature and corresponds in trend. This indicates that several locations of the extract thermistor may be suitable, at or adjacent to one of the extract opening 228 and an outlet opening 226, or at a location between on the main duct 22. For simplicity, only the curve T_{310A} will be described.

At a time t₂, the flow rate is decreased significantly in two steps. The extract temperature T_{310A} directly responds to the decrease in extraction flow rate by increasing correspondingly. The inflow thermistor 340 responds quickly by indicating a sharp increase in temperature. The increase may initially indicate a stagnation of flow into the inflow opening, or even a backflow, as the fans keep operating and the extraction flow rate becomes insufficient to remove the gas drawn by the fans from the process chamber. Without adjusting the extraction flow, the temperature in the main duct increases towards the chamber temperature T₃₃₀. The chamber temperature T₃₃₀ shows a slight increase but does not immediately follow the change in flow rate.

At time t₃, the flow rate is increased over a sequence of steps from a level significantly below to a level significantly above the target steady state flow rate of 200 m³/h. It can be seen how each step change is mirrored by the behaviour of the extract temperature curve T_{310A}. It can also be seen that the response by the inflow thermistor 340 is not as significant, although the increased inflow of cooler gas from the external environment causes a small decrease in the temperature level that may be expected during normal operation. Meanwhile, there is little indication of a change in chamber temperature T₃₃₀, which may be due to one or more of the heat sources within the process chamber being feedback controlled based on for example the build bed area temperature.

At a time t₄, the extraction flow is returned to the target flow rate of 200 m³/h, and the thermistor readings return to their expected measurement levels. This graph therefore illustrates that the extract thermistor readings may be used effectively to determine whether the extraction flow rate is at the allowable level during the build phase, when the process chamber is at or near the operational target temperature Tₒₚ. The temperature of gas flowing through the main duct 22 was found to have a substantially linear response to the flow rate applied by the external extraction source 80.

During the initial stage of the warm up phase, the temperature curve T_{310A} sharply increases and during at least the initial stage of the warm up phase, the extract thermistor readings are not reliable to predict extraction flow rate. Instead, the main duct thermistor 320 and heater 410 heated to a baseline temperature may be used as described herein, or the extract thermistor 310 in combination with the inflow thermistor 340. An example of how temperature readings during the warm up phase may be used to assess extraction flow rate will now be described with reference to FIG. 12.

FIG. 12 is a graph obtained from temperature measurements by the extract thermistor 310 located at or near the extract opening of the main duct 22, and one of the inflow thermistors 340 of the secondary ducts during the warm up phase of the apparatus. The curves correspond to the ratio of extract temperature over inflow temperature, T₃₁₀/T₃₄₀, measured at four different flow rates. The top curve is the behaviour of the temperature ratio against time at the target extraction flow rate R of 200 m³/h. From an equal temperature measured initially from a cold state, the ratio is one, indicated by the dotted line. The warm up phase was repeated three more times, for flow rates of 150 m³/h, 50 m³/h and 0 m³/h. It can be seen how a range of higher flows lies above the equal temperatures line where the extract temperature T₃₁₀ is higher than the inflow temperature T₃₄₀, and a low range, or no flow, for which the extract temperature T₃₁₀ is lower than the inflow temperature T₃₄₀, lies below. Below the dotted line, there is a build up of heat within the main extract duct 22, which may for very low or no flow rates lead to backflow of process chamber gas out of the inflow opening. Until the process chamber temperature starts to increase sufficiently over ambient temperature, by say 5-10° C., all curves are the same irrespective of flow rate. For this very early state of the warm up phase, the ratio does not indicate flow rate. However, a short while into the warm up phase, which in this case corresponded to a few minutes, the curve trends clearly separate. By generating a set of predetermined curves at different flow rates, the extraction flow rate may be determined from the model curves by comparing the measured ratio against it. This may be done over different time intervals and the controller may be configured to generate suitable alerts as described herein. Thus by monitoring the trend in the ratio, and comparing it to predetermined data, it is possible to determine whether the extraction is on or off, or whether it is at the expected target level. As described before, the main duct thermistor 320 and heater 410 may be used to determine flow rate during an idle phase or during the first 5 to 10 min of the warm up phase.

An earlier determination of flow rate, during the early stage at which the ratio is around 1, may be achieved by the arrangement described with reference to FIG. 3.

### Chamber Thermistor 330 and Location in the Drawings and its Use

The controller may thus be configured to determine, or to receive an indication, whether the temperature of the chamber environment is below or at the predefined operational target temperature, or at or above the predefined transition temperature to switch between thermistor measurements. The determination or indication may be the result of the controller 70 monitoring and comparing the temperature measured by a chamber thermistor 330 to the predefined transition temperature and/or the predefined operational target temperature Tₒₚ.

The apparatus or any of its variants disclosed herein may therefore further comprise the chamber thermistor 330 as indicated in for example FIGS. 7 and 8. The chamber thermistor 330 is configured to detect a temperature of gas within the process chamber and may be arranged at a location on or within the secondary duct 24 or within the process chamber 10 to monitor substantially the temperature of the chamber environment. For example, it may be located at the ceiling of the chamber 10 close to a chamber outlet 120, or at or close to the process chamber outlet or to the inlet opening 224 of the secondary duct.

The controller may further be configured to compare, at one or more instances, the temperature T₃₂₀ measured by the main duct thermistor 320 to the baseline temperature T_{base}, and either: upon determining that the measured temperature T₃₂₀ is equal to or higher than the baseline temperature T_{base}, to generate an alert that the extraction flow rate is not present or insufficient for reliable operation of a build phase; or upon determining that the measured temperature T₃₂₀ is lower than the baseline temperature T_{base}, to compare the measured temperature to a predetermined model of extraction flow rate versus measured temperature T₃₂₀, and, upon determining that the measured temperature T₃₂₀ indicates an extraction flow rate below a target range of extraction flow rates, to generate an alert that the extraction flow rate is not sufficient. Upon determining that the measured temperature T₃₂₀ is lower than the baseline temperature, the controller may be configured to monitor temperature measured by the extract temperature sensor 310 T₃₁₀ and to compare the measured extraction temperature T₃₁₀ to a predetermined model of extraction flow rate versus measured extraction temperature, and, upon determining that the measured extraction temperature T₃₁₀ indicates an extraction flow rate outside a target range of extraction flow rates, to generate an alert indicating that the extraction flow rate requires adjustment. Furthermore, the chamber thermistor measurements T₃₃₀ may be used to cross check whether the process chamber is at a temperature at which the method of flow determination applied by the controller are to be based on the temperature measurements of the extract temperature sensor 310 T₃₁₀. This may be after the first 5-10 min into the warm up phase, for example, or when the process chamber is near to or at the target operational temperature Tₒₚ.

The chamber temperature sensor 330 may be arranged at any suitable location of the secondary duct, and/or it may be integrated within the flow device 40. Alternatively, the chamber temperature sensor 330 may be arranged within the process chamber 10.

A predetermined range or dataset indicating allowable flow rates may be provided by measuring temperature at the relevant temperature sensors as described herein for different flow rates for the respective build phase. This means, temperature measurements at different flow rates by the extraction source 80 and for different temperature conditions within the chamber, optionally as measured by the chamber thermistor 330, are taken: for the warm up phase, by the main duct thermistor 320 on or adjacent a heater 410 at the baseline temperature, or the inflow thermistor 340 and extract thermistor 310A; for the build phase, or when the system is at stable thermal conditions, measurements by at least the extract thermistor 310.

In addition, measurements may be taken against a range of flow rates provided by the one or more flow devices 40.

To predetermine the behaviour of temperature and flow rate, a reference flow meter device may be used to produce reference data versus measured temperature by the thermistor against a range of applied flow rates during the desired process conditions. The resulting temperature and flow rate data, acquired within a known and regulated environment, may represent the predetermined data.

The resulting data may be used as a training data set to generate and refine a model for temperature-flow behaviour that may be used by the controller during subsequent monitoring of the extraction flow. In some cases, the data may simply be provided in the form of a look up table defining allowable ranges of data based on or represented by the measured temperature(s). The predetermined data may further be used as a training dataset. Thus, the measured temperature may be compared to a predetermined model of extract flow rate against temperature measured by the extract thermistor 310, and the determined flow rate may be compared to a predetermined allowable range of flow rate.

The predetermined data set may be applicable to more than one apparatus operating at substantially the same conditions. Optionally, the predetermined data set may be tuned per machine by testing some but not all of the data points and extrapolating a tuned data set from the tested data points.

Once a dataset has been determined, it may be stored locally as an apparatus-specific dataset or model, on a data storage device accessible by the controller. The data storage device may be an internal memory of the apparatus on which the tests were performed, or a remote database accessible by the controller via a network. The controller 70 as described herein may be a computer or microprocessor provided with a program that, when executed, causes the steps of the present method to be carried out. A computer program may be provided comprising instructions which, when the program is executed by the controller, e.g. a computer, cause the controller or computer to carry out the method and its variants as described herein so as to determine flow rate based on the training data set and generate alerts as described herein. This may comprise one or more of: measuring, using the chamber temperature sensor 330, a chamber temperature of gas entering the extraction duct from a process chamber side, the measured temperature indicating the temperature of gas within the process chamber; measuring, using the inflow temperature sensor 340, an inflow temperature of gas entering the extraction duct from an inflow opening, the measured temperature indicating the temperature of an ambient environment external to the apparatus; and measuring, using the extraction temperature sensor 310, an extract temperature of gas, the measured extract temperature indicating a combined temperature of gas within the process chamber and of gas entering the extraction duct from an inflow opening.

The method may comprise measuring, or monitoring, the chamber temperature of gas with the chamber temperature sensor 330; comparing the measured chamber temperature to a predefined model of chamber temperature; and determining whether a target operational temperature Tₒₚ has been reached within the process chamber 10. Upon determining that the target operational temperature Tₒₚ has been reached within the process chamber, the method may comprise: monitoring the extract temperature of gas, the measured extract temperature indicating a combined temperature of gas within the process chamber and of gas entering the extraction duct from an inflow opening; comparing the measured extract temperature to a predetermined model to determine an extraction flow rate based on the measured extract temperature; and, upon determining that the extraction flow rate is outside of an allowable range of extraction flow rates, generating an alert. Additionally, or instead, upon determining that the target operational temperature has not been reached within the process chamber, the method may comprise: monitoring the inflow temperature of gas, the measured inflow temperature indicating the temperature of an ambient environment external to the apparatus; comparing the measured extract temperature to a predetermined model T₃₁₀ to determine an extraction flow rate based on the measured extract temperature; and, upon determining that the extraction flow rate is outside of an allowable range of extraction flow rates, generating an alert. The method may comprise heating the main duct thermistor 320 by a heater 410 to a baseline temperature T_{base}, wherein T_{base} is between the ambient temperature of gas entering the inflow opening 222 and a threshold temperature Tₜₕ for safe operation of the apparatus in absence of extraction flow.

In a “warm idle” variant to the methods described herein, the apparatus may be started from a warm state above ambient temperature instead of from a cold (ambient) state, or “cold idle” state as described with reference to FIG. 6. In the “warm idle” state, instead of using the temperature measurements T₃₂₀ by the main duct temperature sensor 320 in combination with the heater 410 providing a baseline temperature, the extraction flow rate applied by the external source of extraction 80 may be estimated using temperature measurements by: the inflow thermistor 340 at or near the main duct inlet 222, the chamber temperature sensor 330 and the extraction temperature sensor 310. In addition, a flow rate Q₂₄ provided by the flow device 40 may be determined—for example, where the flow device is a fan, the flow rate Q₂₄ may be based on a duty cycle at which the fan is operated. With the flow device 40 operating, the flow rate Q₂₂₈ provided by the external extraction source 80 may be estimated as being proportional to the ratio of the differences between the inflow temperature T₃₄₀ and, respectively, the process chamber temperature T₃₃₀ and the extraction temperature T₃₁₀, and if necessary scaled by the flow rate by the flow device: Q₂₂₈∝Q₂₄*(T₃₄₀−T₃₃₀)/(T₃₄₀−T₃₁₀). Q₂₄ may be set to a constant value during operation and may also be treated as a constant.

In normal operation, the inflow temperature T₃₄₀ detected by the inflow temperature sensor 340 is close to or equal to ambient temperature and should be lowest of the three temperatures measured. The extraction temperature T₃₁₀ measured by the extraction temperature sensor 310 should be lower than the (warm) process chamber temperature T₃₃₀. When the extraction flow from extraction source 80 is insufficient, the ratio of temperature differences gets smaller rapidly as the process chamber heats up to operational temperature, and failure can be detected when the ratio falls below a predetermined value.

In this case, at block 140 of Fig, 1, the method comprises: based on the measured temperature at the one or more locations and based on the flow rate applied by the flow device 40 to at least one of the secondary ducts 24, estimating a “theoretical” flow rate applied by the external extraction source 80, and determining from the estimated flow whether an extraction flow rate is present, or within a predefined range. The temperature measurements in this case may comprise the inflow temperature T₃₄₀ measured by the inflow thermistor 340 at or near the inlet 222 of the main duct, the process chamber temperature T₃₄₀ measured by the chamber temperature sensor 330, and the extraction temperature T₃₁₀ measured by the extraction temperature sensor 310 arranged at a location at, or between, the extraction opening 228 of the main duct 22 and the outlet opening 226 of the secondary duct 24. From initial measurements of process chamber temperature T₃₄₀, the controller may be configured to determine, in the idle state, whether the process chamber is already warm, for example above the baseline temperature, and whether to apply the “warm idle” variant or the “cold idle” variant of the method to determine the level or presence of extraction flow. Furthermore, once the warm up process is complete and it has been established that extraction is sufficient, the controller may be configured to apply a “watchdog” mode in which only the inflow temperature is monitored during the build process. Should extraction fail, this inflow temperature rapidly rises and failure may be detected. A determination of whether the temperature measured by the main duct temperature sensor 320 is equal to or higher than the baseline temperature T_{base} may comprise determining whether the measured temperature is above a predefined baseline range, which may be a range from below baseline temperature T_{base} up to, including or above the baseline temperature T_{base}.

1. An apparatus for the formation of 3D objects by additive manufacturing, the apparatus comprising:
a process chamber within which the 3D objects are formed during use, wherein, during object formation, the process chamber comprises gas at a temperature higher than gas in an environment external to the process chamber;
a gas extraction duct configured to guide gas out of the process chamber; and
a controller;
wherein the gas extraction duct comprises:
a main duct having an extraction opening connectable to an extraction source and an inflow opening configured to draw in gas from an environment exterior to the process chamber;
a secondary duct having an inlet opening connected to a process chamber outlet and an outlet opening coupled to the main duct between the extraction opening and the inflow opening; and
one or more temperature sensors thermally coupled to the interior of the gas extraction duct, and arranged to measure, directly or indirectly, temperature of gas flow at one or more locations within the gas extraction duct; the one or more temperature sensors comprising at least one of:
an extraction temperature sensor arranged at a location at, or between, the extraction opening of the main duct and the outlet opening of the secondary duct; and
a main duct temperature sensor arranged to sense temperature of gas within the main duct, and a heater arranged to provide a baseline temperature to the main duct temperature sensor;
wherein, in use, the controller is configured to determine, based on the measured temperature, whether a gas flow rate applied by the extraction source is within a predefined range.

2. (canceled)

3. The apparatus of claim 1 comprising the extraction temperature sensor, wherein the controller is configured to determine, or to receive an indication, that the process chamber environment is at a target operational temperature; and
upon the determination or indication that the process chamber environment is at the target operational temperature, to compare a temperature measured by the extraction temperature sensor to a range of predetermined temperatures indicating an allowable range of flow rates.

4. The apparatus of claim 1, further comprising an inflow temperature sensor arranged at or adjacent the inflow opening of the main duct, wherein the inflow temperature sensor is mounted to a surface of the main duct wall, and wherein the controller is configured to monitor the measured temperature by the inflow temperature sensor, compare the measured temperature to a predefined threshold temperature, and, based upon determining that the measured temperature exceeds a predefined threshold, to generate an alert that the extraction flow rate is not sufficient and optionally to discontinue operation of the apparatus.

5. The apparatus of claim 4, wherein the controller is configured to determine, or to receive an indication, that the temperature of the process chamber environment is below a predefined operational target temperature; and, upon the determination or indication that the temperature of the process chamber environment is below the predefined operational target temperature, to compare the temperatures measured by the extraction temperature sensor and the inflow temperature sensor to determine an operational state of the extraction source.

6. The apparatus of claim 5 and comprising the extraction temperature sensor arranged at a location at or adjacent to the extraction opening of the main duct;
wherein the controller is configured to determine, or to receive an indication, that the process chamber temperature is below a predefined operational target temperature; and, upon the determination or indication that the process chamber temperature is below the predefined operational target temperature, to compare the temperature measured by the extraction temperature sensor against the temperature measured by the inflow temperature sensor to determine an operational state of the extraction source; and
upon determining that the temperature measured by the extraction temperature sensor is lower than a temperature measured by the inflow temperature sensor, to generate an alert indicating that the flow of extraction is insufficient; or,
upon determining, by comparing the ratio of temperature measured by the extraction temperature sensor and the inflow temperature sensor to a predetermined range of ratios, that an extraction flow rate is too low, to generate an alert indicating that the flow of extraction is insufficient and, optionally, to discontinue operation of the apparatus.

7. The apparatus of claim 1 comprising the main duct temperature sensor and heater, wherein the heater is operable to provide to the main duct temperature sensor a baseline temperature above an ambient temperature outside the inflow opening, and wherein:
the main duct temperature sensor is mounted to an internal surface of the main duct, and the heater is mounted between the main duct temperature sensor and the internal surface or adjacent to and thermally coupled to the main duct temperature sensor; or
the main duct temperature sensor is mounted to an external surface of a thermally conductive wall portion of the main duct, between the heater and the external surface, or adjacent to and thermally coupled to the heater.

8. (canceled)

9. The apparatus of claim 1 comprising the extract temperature sensor and the main duct temperature sensor and the heater, wherein the controller is configured to compare the temperature measured by the main duct temperature sensor to the baseline temperature, and either:
upon determining that the measured temperature is equal to or higher than the baseline temperature, to generate an alert that the extraction flow rate is not present or insufficient; or
upon determining that the measured temperature is lower than the baseline temperature, to monitor temperature measured by the extraction temperature sensor and to compare the measured extraction temperature to a predetermined model of extraction flow rate versus measured extraction temperature, and, upon determining that the measured extraction temperature indicates an extraction flow rate outside a target range of extraction flow rates, to generate an alert indicating that the extraction flow rate requires adjustment.

10. The apparatus of claim 1, further comprising a process chamber temperature sensor located at or adjacent the process chamber outlet or located within the process chamber, wherein the process chamber temperature sensor is configured to detect a temperature of gas within the process chamber; and wherein the controller is configured to determine whether the process chamber temperature is below or at the predefined operational target temperature by comparing the temperature measured by the process chamber temperature sensor to the predefined operational target temperature, and optionally wherein the controller is further configured to determine an extraction flow rate based on the temperature measured by the extraction temperature sensor and the process chamber temperature sensor.

11. (canceled)

12. The apparatus of claim 1, comprising the main duct temperature sensor and the heater, the extraction temperature sensor and a chamber temperature sensor located at or adjacent the process chamber outlet or located within the process chamber, wherein the process chamber temperature sensor is configured to detect a temperature of gas within the process chamber, wherein the controller is configured to:
determine, during an idle phase of the apparatus at which the process chamber is at ambient temperature, that extraction flow is present based upon determining that the temperature measured by the main duct temperature sensor is below the baseline temperature;
monitor temperature measurements by the process chamber temperature sensor and compare the process chamber temperature to a predefined transition temperature within a warm up phase during which the process chamber is heated to the operational target temperature; and
monitor, based upon determining that the process chamber temperature is at or above the predefined transition temperature, temperature measurements by the extraction temperature sensor, compare the measured extraction temperatures to a predetermined range of allowable extraction temperatures indicating an allowable range of extraction flow rates, and, upon determining that the measured extraction flow rate is outside the predetermined range, generate an alert that extraction flow is to be adjusted; wherein the predefined transition temperature is equal to or below the target operational temperature, or
wherein the secondary duct comprises one or more flow control devices and the main duct comprises the inflow temperature sensor at or near the inflow opening, and the controller is configured to estimate a theoretical flow applied by the extraction source based on the measured temperatures by the inflow sensor, the extraction temperature sensor and the chamber temperature sensor, and from the theoretical flow value determine whether the extraction flow is outside the predetermined range, and generate an alert if the extraction flow is outside the predetermined range.

13. (canceled)

14. The apparatus of claim 1, wherein the process chamber outlet is comprised within a ceiling of the process chamber, wherein the process chamber outlet comprises a first process chamber outlet and a second process chamber outlet facing either side of a process area arranged within the floor of the process chamber, and wherein the outlet opening of the secondary duct is in fluid communication with the first and second process chamber outlets via a first secondary duct and a second secondary duct, respectively, optionally wherein the first and second secondary ducts each comprise a flow control device.

15. The apparatus of claim 12, wherein the outlet opening comprises a first outlet opening and a second outlet opening, and wherein the first and second secondary ducts respectively comprise the first and second outlet openings, and/or wherein: the apparatus comprises the extract temperature sensor and the main duct temperature sensor and the heater, the first and second secondary ducts are combined at a combined portion of the secondary duct, the outlet opening is the outlet of the combined portion, and the combined portion comprises a flow control device.

16. (canceled)

17. The apparatus of claim 1, wherein the secondary duct comprises one or more flow control devices.

18. (canceled)

19. (canceled)

20. (canceled)

21. The apparatus of claim 1, wherein the controller is configured to compare the measured temperature to a predetermined range of temperatures, the predetermined range of temperatures indicating a range of sufficient flow rates.

22. A method of determining an extraction flow rate of gas extracted by an external extraction source from the apparatus according to any preceding claim, the method comprising:
measuring temperature at one or more locations of the extraction duct;
comparing the measured temperature to a predetermined temperature model or to a predetermined temperature range, based on one or more flow rates applied by the external extraction source, or, wherein the secondary duct comprises one or more flow control devices, estimating an estimated flow rate applied by the extraction source based on the measured temperature at the one or more locations and based on a flow rate applied by the flow control device;
determining whether the measured temperature or estimated flow rate indicates an allowable predefined range of extraction flow rate for an object build process of the apparatus.

23. The method of claim 22, wherein measuring comprises one or more of:
measuring, with an or the chamber temperature sensor, a chamber temperature of gas entering the extraction duct from a process chamber side, the measured temperature indicating the temperature of gas within the process chamber;
measuring, with an extraction temperature sensor, an extract temperature of gas, the measured extract temperature indicating a combined temperature of gas within the process chamber and of gas entering the extraction duct from an inflow opening;
heating the main duct temperature sensor with the heater, and measuring the temperature of the main duct temperature sensor; and
measuring, with an or the inflow temperature sensor, an inflow temperature of gas entering the extraction duct from an inflow opening, the measured temperature indicating the temperature of an ambient environment external to the apparatus.

24. The method of claim 23, comprising, during an idle phase of the apparatus at which the process chamber is at ambient temperature, heating the main duct temperature sensor with the heater to a baseline temperature, and measuring the temperature of the main duct temperature sensor, and comparing the measured temperature to the baseline temperature so as to determine whether an extraction flow is present.

25. The method of claim 23, comprising measuring the chamber temperature of gas, comparing the measured chamber temperature to a predefined model of chamber temperature, and determining whether a target operational temperature has been reached within the process chamber, wherein, upon determining that the target operational temperature has been reached within the process chamber, monitoring the extract temperature of gas, the measured extract temperature indicating the temperature of a combined flow of gas into the main duct from the process chamber and of gas entering the inflow opening; comparing the measured extract temperature to a predetermined model to determine an extraction flow rate based on the measured extract temperature; and, upon determining that the extraction flow rate is outside of an allowable range of extraction flow rates, generating an alert.

26. The method of claim 24, wherein, upon determining that the target operational temperature has not been reached within the process chamber;
monitoring the inflow temperature of gas, the measured inflow temperature indicating the temperature of an ambient environment external to the apparatus; comparing the measured extract temperature to a predetermined model to determine an extraction flow rate based on the measured extract temperature; and, upon determining that the extraction flow rate is outside of an allowable range of extraction flow rates, generating an alert.

27. The method of claim 22, comprising measuring the chamber temperature of gas, determining whether the measured chamber temperature is substantially ambient temperature or a temperature between a baseline temperature provided by the heater and a target operational temperature of the process chamber, and
when the measured chamber temperature is substantially ambient temperature, comparing the temperature measured by the main duct temperature sensor to the baseline temperature, and upon determining that the measured temperature is at or above the baseline temperature, generating an alert that the extracting flow rate is insufficient; or
when the measured chamber temperature is between the baseline temperature and a target operational temperature, estimating a theoretical flow value applied by the extraction source based on the measured temperatures by the inflow sensor, the extraction temperature sensor and the chamber temperature sensor, and generating an alert that extraction flow is insufficient if the theoretical flow value is below a predefined theoretical flow value.

28. The method of claim 27, comprising, upon the process chamber reaching the operational temperature, monitoring an inflow temperature of gas entering the extraction duct from an inflow opening, and generating an alert that extraction flow is insufficient if the inflow temperature rises above a predetermined threshold above ambient temperature.
